(19) United States
(12) Patent Application Publication
(10) Pub. No.: US 2005/0137887 A1
(43) Pub. Date: Jun. 23, 2005

(54) Net-effect arrangement inheritance

(75) Inventors: Howard Keith Porter, Durham, NC (US); David E. Grining, Graham, NC (US); Michael J. Croasdaile, Germantown, WI (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/739,837

(22) Filed: Dec. 18, 2003

(51) Int. Cl. G06F 17/60

(52) U.S. Cl. 705/1; 705/11

(57) ABSTRACT

A rules based management program that allows a set of rules that is used to create an ancestor catalog to be inherited by a lower level organization and immediately used to create a catalog for the lower level organization. The lower level organization can tailor the catalog to meet the needs of its customers by adding one or more explicit rules to the set of rules. The new set of rules may then be inherited by an even lower level organization and again immediately used to create a catalog for the even lower level organization. The even lower level organization can also tailor the catalog to its needs by adding its own explicit rules to the set of rules. The rules are used to dictate what is included in or excluded from a particular catalog. The rules are also used to determine prices for the products, services and capabilities that are offered in the catalogs. The rules act only on data, or items, that are in effect at that time and in a specified location.

### BACKGROUND OF THE INVENTION

The present invention relates generally to the field of electronic catalogs and more specifically to a method for creating and managing electronic catalogs.

Electronic catalogs are similar to traditional paper catalogs in that they can be used to display the products, services and capabilities of a company. Electronic catalogs, however, are much more flexible than paper catalogs in that they can be quickly updated and can also be used in a manner similar to databases. Electronic catalogs can store legal and technical information, which an authorized customer can access and use to produce contracts and proposals. Electronic catalogs may also offer multiple capabilities to customers. For instance, an electronic catalog can offer different types of capabilities for such things as reporting formats, invoicing procedures and distribution methods to a customer.

Large international corporations, such as International Business Machines Corporation (IBM), have large numbers of electronic catalogs that are used to offer a wide range of products and services to buyers in many different countries. Managing such a large number and wide variety of catalogs is a daunting task. To complicate matters further, large organizations often have multiple arrangements with other business partners. These large organizations and business partners can simultaneously fill different roles such as customer, vendor, and regulatory agency. These organizations have a need to quickly understand all relationships that are in place when conducting business with a partnering organization in given role. Customers often are so decentralized both from a geographic and functional perspective that they do not understand the terms and conditions that have been negotiated across their organization. For instance IBM is a customer of The Intel Corporation (Intel), and Intel is a customer of IBM. IBM as a supplier needs to have readily available the terms and conditions they have in their role as an Intel supplier. Without this information being quickly available some windows of opportunity are missed.

In traditional management systems, a price change to one item would require each catalog that offered the item to be accessed individually so that the price of the item could be changed. The same is true for new products that are to be added to multiple catalogs. Each catalog would have to be accessed individually in order to add the new product. Typically large corporations have a multitude of changes to one or more of their products on a daily basis. As one might imagine keeping all of the corporations catalogs updated requires a large number of support staff that do nothing else other than update catalogs.

One method for managing electronic catalogs is known as an event driven method. In an event driven method predefined events are tracked through stages, which trigger other subsequent events. In traditional programming environments, status codes have been used to identify what stage something is in such as an item being released to catalog for purchase by customers. When an item receives a new status, its status code is overwritten. To track historical data in this environment requires that separate status tables be set up for each item in the catalog. This involves significant programming and also takes up a large amount of database space. Another problem with traditional catalog systems is the long amount of time required to create a new catalog for a customer. Traditionally, a database type structure was created and each item to be offered from the catalog was added individually. Different views of the catalog, for customers and administrators, also had to be custom created in accordance with the programming environment being used. These traditional methods are extremely time consuming and do not offer a large degree of compatibility with the systems of the customers.

Some customers want to be able to define their catalog offering requirements to a provider on one day and have them available for ordering the next. In some cases the customer expects availability within hours, or minutes. Traditionally, the business processes for responding to a requirements proposal, preparing for fulfillment of proposal items, and definition of the items for ordering are done by disjoint business processes and incompatible enabling infrastructures. Movement of data through these processes causes delays because of data conversion and integrity problems. This in turn negatively impacts customer satisfaction and often is a cause for lost sales.

The complexity of country specific requirements coupled with high numbers of offering types is another traditional problem making it impossible to efficiently manage and track items internationally. Businesses have a need to keep track of identical items regardless of the country in which the item is sold. However, the same item is traditionally assigned different number identifiers in different countries because of process and technology nuances in each country. The growing trend in today's market is to have international agreements for items. Customers want a common, simple identification scheme regardless of where the item is ordered, paid for, shipped from or delivered to. This problem requires someone or some system to keep track of all the item numbers by geography in all parts of the world. There can be 1,000's of numbers to be tracked and 100's of computer systems to coordinate. There is a need for a solution in this area.

Another management problem exists in the hardware manufacturing industry where changes to components happen rapidly and continuously. Because hardware components are used in thousands of configurations, it has been extremely difficult to determine every structure in which a component is being used. Customers, marketers and sellers traditionally are unable to tell if an offering in a catalog is obsolete at any point in the order management cycle. An item or a component of an offering can reach its end-of-life (EOL), and become obsolete, at anytime. These EOL events are scattered across many systems and it is nearly impossible to stay current with them. Also, these EOL transitions apply to any type offering or component at any level; software, service, building block, capability, etc. Keeping track of the thousands of components that require substitution because they have reached their EOL must be addressed.

As the number of catalogs have proliferated across geographies, it has become nearly impossible to maintain visibility of all the permutations of fulfillment choices and constraints. Problems arise when a seller is authorized to sell to a geographical area, but the suppliers can only fill orders to a specific sub-zone within the geography, or the supplier is no longer able to fill any orders. This problem is exacerbated by the fact that once a customer catalog is established the fulfillment options can change independently. Further these fulfillment changes can occur anytime between proposal acceptance, contract creation, order processing, fulfillment and providing service support. Historically catalogs have covered large customer bases, i.e., the Sears Roebuck North American catalog. That notion is changing dramatically. Catalogs are now being built for individual customers, as well as to provide regional coverage. Catalogs can be built for a customer segment or for individual marketing groups. However, the managing organization must maintain a knowledge base of all sellers' catalogs across all geographies, sub-geographies and other areas where orders may be fulfilled.

A further problem exists in offering new capabilities to customers. Currently, obtaining and clarifying customer requirements that lead to the creation of new business capabilities as offerings to support customer requirements has been an error prone and time consuming effort. In addition, traditional catalogs have been a “one way” communication vehicle that sells products to a customer. This has caused businesses to expend considerable time and effort in continually building new custom priced business capabilities that are virtually identical to ones created for other customers. The problem is that there is currently no efficient way to organize and present these new business capabilities as offering services or part of other offerings. As a result the customer requirements gathering process generates excessive initial effort to define the offering, price and develop a capability that may already have been developed for other customers. In addition, because the rigor of a catalog definition is lacking, there is a great deal of effort expended to correct errors during the requirements gathering process. These factors drive up the cost of the offering development and make it impossible to re-use already developed business capabilities in a near real-time environment.

Getting products in front of customers quickly enough to support what they want to buy is another traditional problem. Businesses have a need to ensure the content of their catalogs reflect what can be offered to their customers. There can be customer catalogs, marketer segment catalogs, and seller segment catalogs that must be maintain across multiple levels of geographical areas and business units. This translates into thousands of catalogs that must be maintained. Further, each catalog has unique inclusion entitlements to be assessed against tens of thousands of candidate catalog items whose mix is constantly changing. Traditional methods were developed for low volumes of catalogs and stable offerings over time. There is a need for a new management method that does not become overwhelmed as traditional methods have.

Data associated with electronic catalogs are typically stored on special computers known as servers and accessed via a network. Small networks called local area networks, or LAN's, and are traditionally used to connect computers within a single building or complex. Metropolitan area networks, or MAN's, refer to networks that connect computers throughout a city. Wide area networks, or WAN's, connect geographical areas larger than a city. The Internet, which is a worldwide network, can be considered the ultimate WAN. The hardware and software used to set up and run a network is referred to as the network's infrastructure. The Internet is an association of computer networks with common standards, which enable information to be sent from any host on one network to any host on another network. Originally developed in the 1970's to support military research, the Internet has since grown and expanded to support commercial, educational, and other users. The World Wide Web is an Internet facility designed for multimedia use, in which individuals or organizations make available ‘pages’ of information to other users anywhere in the world. The Internet uses a client-server architecture to control the sending and receiving of information. During their travels across the Internet, requests and responses will likely encounter one or more gateways and routers. Gateways are located between computer networks and enable a network operating according to one protocol to pass messages to a second network working on a different protocol. Routers are devices that push traffic through a packet-switched network. As used herein, requests, responses, messages, traffic and packets each refer to digital information traveling over a network. In the Internet, routers are used to determine the best possible route for packets to reach their destination and forward the packets along that route.

### SUMMARY OF THE INVENTION

In a rules based management system, a method that allows a first participant in the system to inherit rules from a marketer. The rules are used to create a catalog for the first participant each time the participant logs on to the system. The method involves listing all items that are available world wide from the marketer in a marketer's base catalog. The items include products, services and capabilities offered by the marketer. Each item is assigned an effectivity period, during which a specified item is considered to be in effect, and an effectivity location, wherein the effectivity location defines an area that the specified item is considered to be in effect. A base set of rules is associated with the marketer's base catalog. This base set of rules relate to item inclusion or exclusion, pricing, or presentation layout. Each rule is capable of being inherited by the first participant and by other participants. Each rule is also assigned an effectivity period, during which a specified rule is considered to be in effect, and an effectivity location, wherein the effectivity location defines an area that the specified rule is considered to be in effect. A first participant is then authorized to sell items that are listed in the marketer's base catalog. The first participant is provided with identification information that the participant uses to log on to the system. A subset of rules is assigned to the first participant based on the participant's situational factors including, location and entitlements. The subset of rules is a subset of the base set of rules, and the subset of rules determines what items will appear in the first participant's catalog. A viewable catalog for the first participant is created each time the participant logs on to the system by applying the subset of rules to the items in effect in the first participant's location. Changes to the subset of items, because of items that have either come into effect or gone out of effect, and changes to the subset of rules, because of rules that have come into effect or gone out of effect, are automatically represented in the first participant's viewable catalog the next time the first participant accesses his catalog. The first participant is allowed to add one or more explicit rules to the subset of rules, wherein the first participant is able to tailor his catalog to his needs and the needs of his customers through the addition of the one or more explicit rules.

The subset of rules assigned to the first participant contains either mandatory rules or optional rules. The first participant may unilaterally change or exclude optional rules however; the first participant must obtain permission from the marketer before changing or excluding mandatory rules. The effectivity periods for items and rules are defined by a begin date and an end date. The effectivity locations for items and rules are defined by a geographic space, wherein the geographic space is one or more zip codes, one or more time zones, one or more political geographies or a custom geographic area defined by the marketer.

It is an object of the present invention to greatly reduce the amount of time required to create an electronic catalog for a customer.

It is another object of the present invention to greatly reduce the amount of time required to manage a large number of electronic catalogs.

### BRIEF DESCRIPTION OF THE DRAWINGS

The invention of the present application will now be described in more detail with reference to the accompanying drawings, given only by way of example, in which:

FIG. 1 illustrates the creation of a marketers base catalog;

FIG. 2 illustrates the creation of two other base catalogs;

FIG. 3 illustrates the subdivision of a base catalog;

FIG. 4 illustrates the inheritance of a first set of catalogs;

FIG. 5 illustrates the inheritance of a second set of catalogs;

FIG. 6 illustrates the inheritance of a base catalogs;

FIG. 7 illustrates the subdivision of a seller's base catalog;

FIG. 8 illustrates the inheritance of a base catalog that is specific to a country;

FIG. 9 illustrates the inheritance of a marketer's sub-catalog to a seller's base catalog;

FIG. 10 illustrates the inheritance and consolidation of multiple sets of catalogs;

FIG. 11 illustrates another example of an inheritance and consolidation of multiple sets of catalogs;

FIG. 12 illustrates the inheritance and consolidation of multiple sub-catalogs by a single sub-catalog;

FIG. 13 illustrates which catalog an individual customer would utilize;

FIG. 14 illustrates the inheritance and subsequent subdivision of a base catalog;

FIG. 15 illustrates another inheritance and subsequent subdivision of a base catalog;

FIG. 16 illustrates the ability of a customer to allow internal inheritance and subsequent subdivision of one or more catalogs;

FIG. 17A illustrates the consolidation of rules for the creation of a new catalog;

FIG. 17B illustrates another step in consolidating the rules for the creation of a new catalog;

FIG. 17C illustrates yet another step in consolidating the rules for the creation of a new catalog;

FIG. 18 illustrates the preferred inheritance method for creating a net effects catalog;

FIG. 19 shows some of the multiple views that are available to different users of a viewable catalog of the present system;

FIG. 20 is a flow chart that is used to gather information on a potential customer; and,

FIG. 21 is a flow chart outlining the steps of the preferred net effect catalog inheritance method.

### DETAILED DESCRIPTION OF THE INVENTION

In the present inheritance system there are many types of “participants” involved. These participants include retailers, wholesalers, marketers, developers, manufacturers, distributors, individual customers and system administrators. The present system introduces the idea of Net Effect Arrangement Inheritance for understanding and managing arrangements, including catalogs, negotiated between participants for a given location for a given period of time. The arrangements include historical, current and future arrangements. This system maintains and provides in near-real time information on all arrangements that are in place between participants. The arrangements, which govern the relationship between participants, are provided at scoping, or authorized, levels of geography, parent organizations and category classifications. The arrangements include regulatory relationships that govern what relationships can be negotiated with contracting participants, and relationships among arrangements, i.e., marketing programs in support of marketing messages. A single identifier can be used to define the type of arrangement. Exemplary arrangement types include: Account Plans; Certification Requirements; Catalogs; Industry Standards; Letters of Agreement; Marketing Messages; Marketing Programs; Government Regulations; Powers of Attorney; Customer Fulfillment Orders; Customer Requirement Orders/Contracts; and Vendor Agreements.

The present net effect system will be described using catalog inheritance as an example. The present net effect catalog inheritance system allows the creation of multiple catalogs each one being tailored to the needs of a specific participant. Catalogs that a participant accesses and views are referred to as “viewable catalogs”. Viewable catalogs will typically include text, pictures, charts, links and other objects that provide some value to the participant. Each viewable catalog has associated with it two “internal catalogs”. The first internal catalog is referred to as “catalog rules” or “filters”. The filters contain the rules that are used in the present system. The rules may pertain to inclusion or exclusion of items, pricing of items, characteristics and values, or presentation layouts. An example of a “characteristic” that is used in the present system is storage capacity, and an exemplary value is 10 gigabytes (GB). The second internal catalog is referred to as a “net effect catalog”. Net effect catalogs contain item identifiers (ID's), pricing ID's and viewing criteria. The contents of a net effect catalog are the result of the application of a set of rules that may have been inherited from multiple sources. Hence the term “net effect”. In the catalog inheritance embodiment, the term “items” is used to refer to products, services and capabilities. In other embodiments “items” may refer to other objects. For example, in a net effect contract inheritance system “items” would refer to terms and conditions. “Capabilities” as used in the catalog example refers to capabilities that may be provided by a computer and capabilities that may be provided by humans.

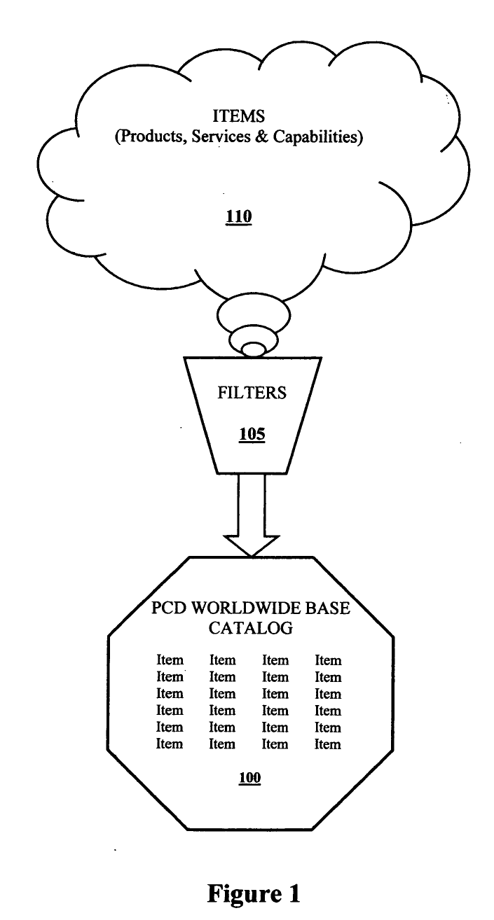

The first step in the catalog inheritance method is to gather all of the items that a marketer wants to offer, world wide, and list those items in a base net effect catalog. FIG. 1 illustrates such a step, wherein the marketer is the personal computer division (PCD) of a large international corporation. The PCD must first put together a base catalog 100 of all items that it wishes to offer world wide. A number of filters 105 are created which provide catalog rules relating to the inclusion or exclusion of the corporation's items 110 in the base catalog 100. Other rules in filters 105 relate to pricing, characteristics and values that will be available. Not all items will have a price associated with it. In the preferred embodiment, there is a set of inclusion/exclusion rules that apply to the inclusion of items and another set of inclusion/exclusion rules that are applied to the first set for the purpose of pricing. Both sets of rules are inherited down an inheritance structure that is discussed further below. Item compatibility with specific countries is handled by a structure outside the catalog, wherein an item is only released in countries in which the item is compatible. The catalog rules only act on those items that have been released in the applicable country or lower level geography. The logic that handles item releasing is independent of the filters. The rules contained in the filters 105 are applied to all of the corporation's items 110 and those items that are selected for inclusion are added to the catalog 100. Besides the corporation's items, other items may also be provided by other manufacturers. Items may also be “released” by a provider for possible inclusion in a catalog. The status of an item is tracked and is used to tell whether or not an item has been released by a provider in a specific location. Every data source that feeds a customer's catalog must respect the integrity rules that support the inheritance business rules of the present system. In other words, the physical manifestation must respect the logical constructs. Core data is essential for effective catalog content management. There should be only one logical source, or virtual source, for all parts data that feeds the customer catalogs for different sellers, market segments, order vehicles, or geographies. This core data must have a structure and organization that codifies it by data type and relationship so that it may be effectively mined using methods such as relational database programming. Since the net effect catalog is an internal catalog, it is not one that an end user accesses and views. The net effect catalog actually only contains item ID's and resultant ID's of pricing rules.

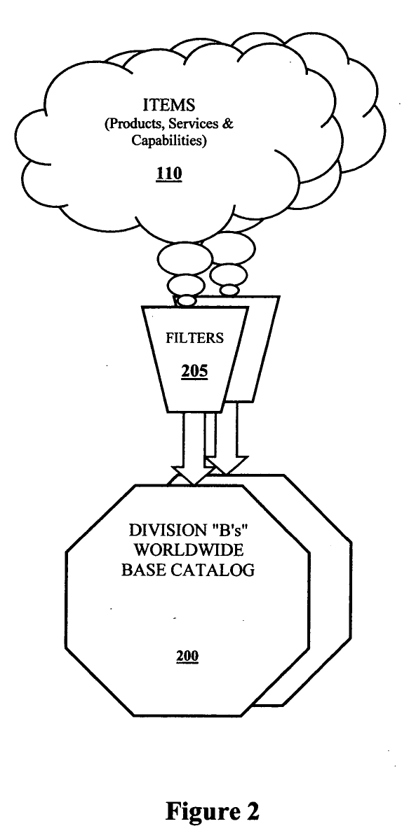

FIG. 2 illustrates the creation of two base catalogs 200 for two other divisions of the marketer. Filters 205, containing appropriate rules, are applied to the list of all of the marketer's items 110 to produce base catalogs 200 for the two divisions. The present method implements a rules based management system, wherein a set of rules are defined, based on a customer's requirements and entitlements, and the rules are applied to a list of items to selectively create a net effect catalog. When a rule is changed the contents or capabilities of the related net effect catalogs are changed. Sub-catalogs can easily be derived from a parent catalog by using the rules of the parent catalog, adding one or more rules specific to the sub-catalog, and applying the new set of rules against the data set associated with the parent catalog. Subsequent descendant catalogs can also be derived from a sub-catalog. Thus, many sub-catalogs, which ultimately derive from the same base catalog, can be created and managed by a single entity using the present rules based management system. This system streamlines the management of multiple catalogs and allows the entity to maintain administrative control over a wide variety of electronic catalogs. The present rules act as filters for the data and each time a different set of rules are applied to the original data a different catalog is created. One of the capabilities available within a catalog includes the types of screens, or views, presented within the viewable catalog and abilities provided to the customer through the use of the screens. Other exemplary capabilities include system administration, ordering, invoicing, customized shipping labels, reporting, asset management, manufacture integration, warranties, return policies, currency conversion and contract creation.

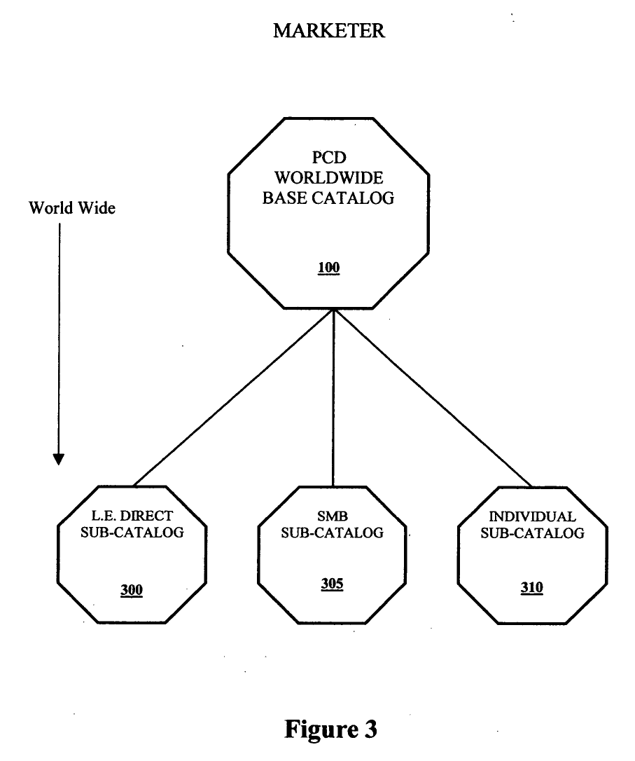

FIG. 3 illustrates the subdivision of the marketer's world wide PCD base catalog 100 into catalogs 300, 305 and 310 that target specific audiences. In this example, the marketer wanted to have catalogs that are tailored to large entities (LE) 300, small and medium businesses (SMB) 305 and individuals 310. To accomplish this subdivision, specific rules for each tailored catalog are added to the rules of base catalog 100. In other words, rules that insure all items the marketer wants made available to his large enterprise customers are combined with the rules that were used to create base catalog 100. This combination of rules is then applied to the items associated with base catalog 100 to create LE Direct sub-catalog 300. To create SMB sub-catalog 305, rules that insure all items the marketer wants made available to his small and medium business customers are added to the rules of base catalog 100. This combination of rules is then applied to the items associated with base catalog 100 and SMB sub-catalog 305 is created. A similar process is followed to create Individual sub-catalog 310. The rules for each catalog are stored and may be changed from time to time, because a new rule has come into effect or an old rule has gone out of effect, or at the request of a customer for example. Each time a rule is changed, the result is apparent in the customer's viewable catalog the next time the customer accesses his catalog. This is so because in the present system the customer's viewable catalog is created each time the customer accesses his catalog. When the customer logs off at the end of a session, the catalog is not stored. Rather, each time the customer accesses his catalog, the rules in effect at that time are applied against the items in effect in that location and a “new” catalog is created for the customer dynamically. The present invention solves the problem keeping catalogs up-to-date by deriving a “new” catalog every time the catalog is needed, i.e., every time the customer accesses his catalog. This eliminates the never-ending task of trying to keep the catalog up-to-date continuously. The building of the catalog is based on real-time application rules. When a new item is released, it is instantly made available to all catalogs that have entitlement rules that scope the item. The present system provides streamlined management because the rules for a commodity environment, i.e., quality, price and manufacturer, change far less often than the actual supply components or parts offered. In an alternative embodiment, explicit rules, which are rules added at the end user's level can be stored when the customer logs off.

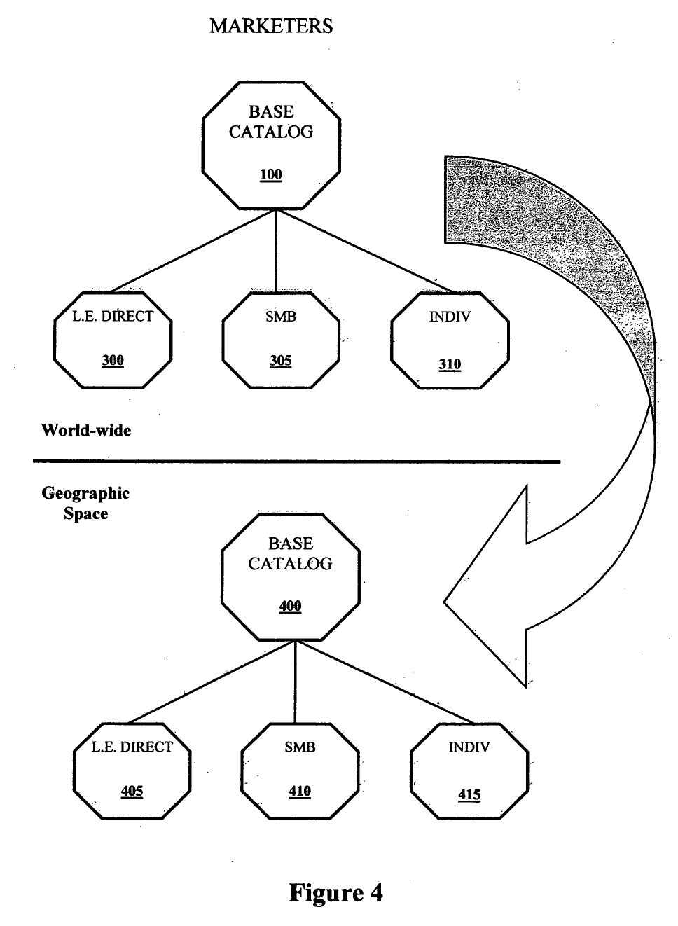

FIG. 4 illustrates the inheritance of one or more world wide catalogs by one or more catalogs that are specific to a geographic region. In this example, a geographic region can be as large as a continent or as small as a postal zone. The filters employed for base catalog 400 are selected in part based on the specific region in which the catalog will be used. Base catalog 400 inherits rules from base catalog 100. These inherited rules are either mandatory or optional. Optional rules may be changed locally by administrators associated with catalog 400. However, changes to mandatory rules may not be activated without prior authorization from the author of the mandatory rule (e.g. a higher level of customer, sales, or marketer). The process of requesting a change to a mandatory rule is called escalation and is the subject of another patent application filed by the same assignee as the present application. Tailored catalogs 405, 410 and 415 are preferably inherited from world wide tailored catalogs 300, 305 and 310, respectively. Tailored catalogs 405, 410 and 415 would not however be identical to world wide tailored catalogs 300, 305 and 310, as rules that are specific to each sub-catalog, called explicit rules, are typically added. The explicit rules in this example would likely be related to the specific region in which the catalogs 405, 410 and 415 will be used. Other base catalogs could have more than three ancestors, and the ancestors could each be used to derive lower sub-catalogs.

In creating filters for sub-catalogs, the key is to define unique catalog items for the specific geographic region (GEO) or customer desired configurations. For example, keyboards and software images are tailored to the various languages spoken by the countries involved. Country specific considerations are handled outside the catalog by a different Item construct called a World Wide (WW) item ID that is linked to geographic specific versions. Catalog rules can be specified in terms of the WW item ID, when the actual inclusion is done. The process determines if there is a geographic specific item available that corresponds to the GEO of the net effect catalog being built. The present system allows the inclusion of a single item in a catalog as a Multi-Geo Product. Then by use of a Inter-Geographic Product Item relation and a Cross Geographic Area Filter construct, each geography can determine which specific ID number gets sent to the offering provider for orders for a particular geography. The manner in which the WW item ID's, which uniquely identify an item as inter-geographic, are defined makes this possible. The principle elements are geographic location, catalog, item, and participant. Each of these elements are defined independently of one another and related such that an item can be in many catalogs (which are a sub-classification of arrangements) and arrangements can span multiple geographies. Since the definition of where an item is released is defined independently from the item, the item can be released and thereby be in effect in many geographies.

Product descriptions must appear in the viewable catalogs in the language of the host countries as well. There are unique catalog offerings for different routes-to-market, sellers (distributors, and third party resellers), and other customers. All of these must be understood for each catalog item. The world wide base catalog can then be filtered based on what is included or excluded from the segmented catalog. This filtering process must follow the rules for selecting the catalog items in a certain order, inheriting the attributes from its parent catalog. For example, Hungary's catalog would not have any items in it that are not a part of its parent catalog. Prices are handled in a similar fashion. For accounting purposes, prices can be assigned at the component level according to some pricing scheme that the business sets (i.e., cost plus percentage). However, prices may also be assigned at any level of component grouping in an item hierarchy. Prices can also be assigned at the component relationship level, i.e., a component in one offering can be priced differently that the same component in another offering. There is a set of pricing business rules for how items can be priced, which is independent of the catalog. These prices will vary for each of the unique catalogs for various factors such as marketing promotions, special bids, or country currency. The viewable catalog would display the prices according to the rules that were applied for its marketing route, seller, or customer. The same filtering process can be applied to product descriptions, catalog graphics, even services and business capabilities. However, services are preferably released in geographic areas just like hardware and software products. The overall process that builds a net effect catalog recognizes whether a service was released in the geographic space covered by the catalog. There may be a case where a service is initially included in a catalog because the service is provided in a portion of the geo space covered by the catalog. In that case, at order time a more focused check needs to be made based on where the service is to be delivered within the geo covered by the catalog. This is true, however, for any type of product. Use of these techniques allows adaptation to a real-time environment and provides improved cycle time for the customers. As a result, the amount of resources required to manage and sell the offerings from tailored catalogs is significantly reduced.

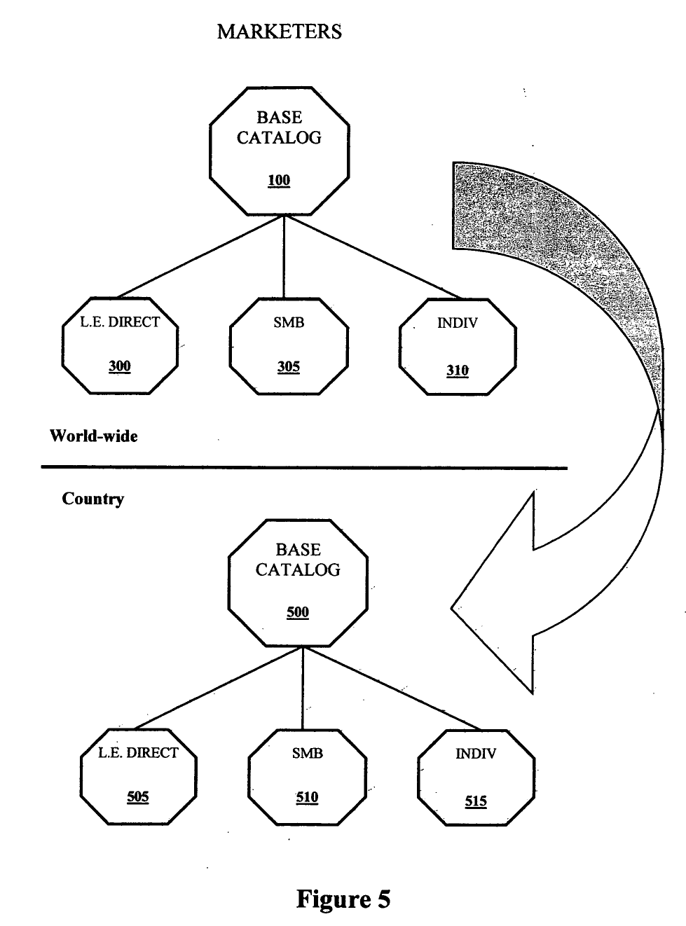

FIG. 5 illustrates the inheritance of one or more world wide catalogs by one or more catalogs that are tailored to a specific country. The filters employed for base catalog 500 are selected based in part on the specific country in which the catalog will be used. Base catalog 500 also inherits the rules from world wide base catalog 100. As mentioned above, the inherited rules are either mandatory or optional. Tailored catalogs 505, 510 and 515 are preferably inherited from world wide tailored catalogs 300, 305 and 310, respectively. Tailored catalogs 405, 410 and 415 would not however be identical to world wide tailored catalogs 300, 305 and 310, as rules that are specific to each sub-catalog, called explicit rules, are typically added. The explicit rules in this example would likely be related to the specific region in which the catalogs 405, 410 and 415 will be used. Other base catalogs could have more than three ancestors and the ancestors could each be used to derive lower sub-catalogs, to further specify target audiences. If tailored catalogs 505, 510 and 515 are not inherited from world wide tailored catalogs 300, 305 and 310, respectively, then the administrator can create the tailored catalogs by segmenting base catalog 500. However, if the desired country segmented catalogs are identical to the segmented catalogs of the world wide base catalog, then inheritance of the world wide segmented catalogs can be employed to save the country administrator time and effort.

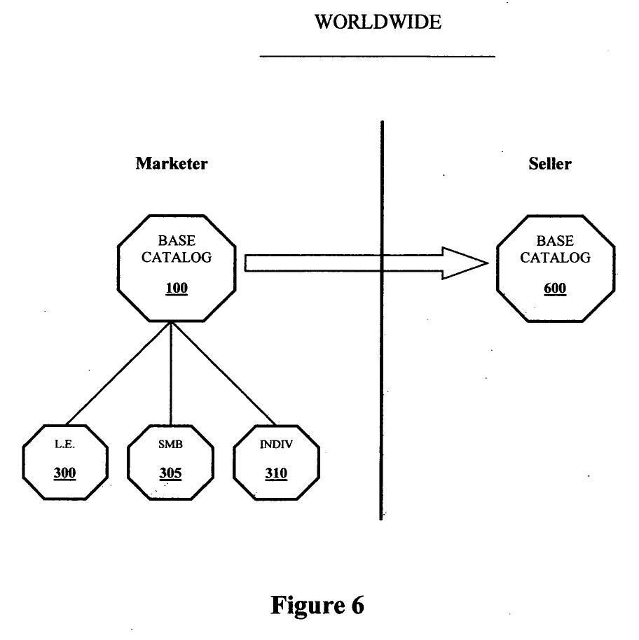

FIG. 6 illustrates a situation where the world wide marketer has authorized a world wide seller to sell items from the marketers' world wide base catalog 100. The marketer may allow the seller to sell directly from catalog 100, or the seller may be required to set up his own catalog structure and then link that structure to catalog 100. By setting up his own catalog structure, the seller may also sell products from catalogs other than catalog 100. If the seller wishes to sell products from more than one of the marketer's catalogs, then the seller is required to set up a dedicated structure. The present method provides a near real-time hierarchical catalog content control that ensure that all catalogs reflect the higher level scoping content rules.

This method implements concept to control the application of include/exclude rules used in determining the content of a catalog at any level of hierarchy in which a catalog may exist. This is done via inheritable mandatory or optional inclusions or exclusions of content rules that can be applied in near real-time.

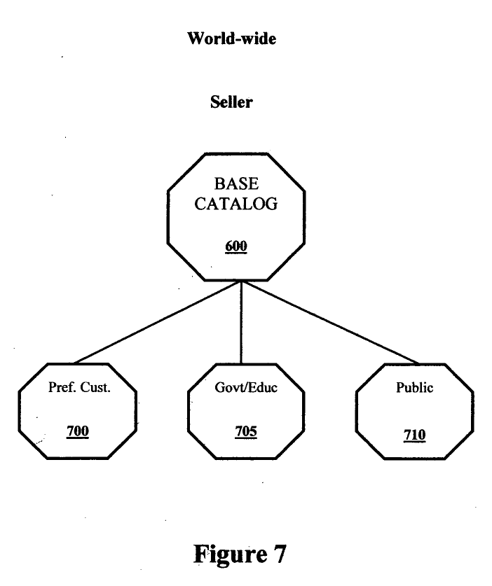

FIG. 7 illustrates actions that a world wide seller may take after establishing his base catalog 600. In this case, the seller has segmented his base catalog 600 into three sub-catalogs that target specific audiences. Preferred customer catalog 700 contains those items that the seller knows his preferred customers desire. Sub-catalog 700 may also include bulk buying discounts or similar discounts. Sub-catalog 705 includes those items that employees of a government or school system would require. Sub-catalog 710 includes those items that the general public would desire. The same item may be listed in each of the three segmented catalogs 700, 705 and 710, however, since explicit rules that are specific for a single catalog may be employed, the same item may have different prices in the three viewable catalogs. In that case, the net effect catalogs would have different pricing rules depending on what was negotiated with the customer. The pricing ID or the pricing algorithm (along with any parameters) shows up in the net effect catalog. The actual price may not be calculated until order time when such things as quantities are known.

This method also address the problem of fulfillment efficiency by providing the ability to accurately validate and track 1,000's of listed offerings, managing the many catalogs they appear in, and correlate them to geographic fulfillment locations. Every seller catalog item is defined with associations to the items and their related geographic fulfillment locations and provider(s). This business capability allows dynamic access to all fulfillment locations for a particular item. Any restrictions are immediately identified preventing a customer order from being inaccurately fulfilled.

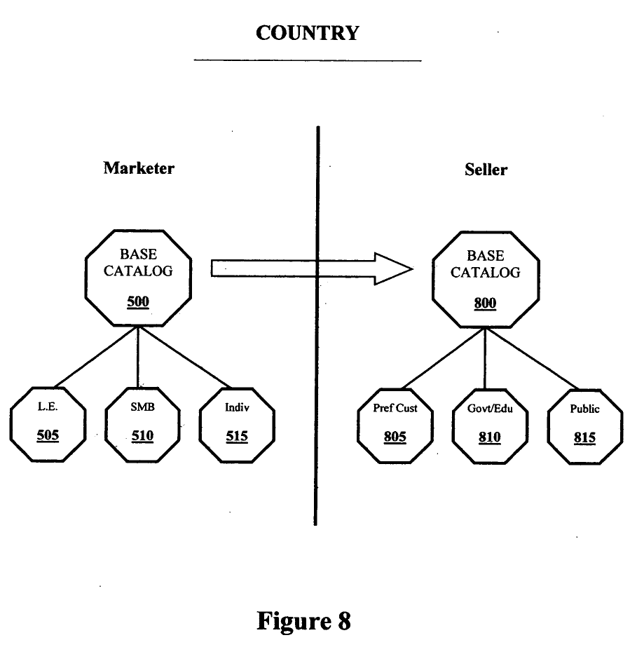

FIG. 8 illustrates the inheritance of a Marketer's country specific base catalog 500 by a seller within the country, thereby creating seller's country specific base catalog 800. Prior to catalog inheritance, the marketer and seller come to an agreement that includes the marketer authorizing the seller to sell items offered by the marketer. In this example, the seller subsequently segments his base catalog 800 into three sub-catalogs 805, 810 and 815 in order to target specific audiences. Sub-catalog 805 is stocked with items that will be attractive to the seller's preferred customers. It is worth restating here that “items” refers to products, services and capabilities. Sub-catalog 810 includes items that the seller believes will be attractive to governments and school systems. Sub-catalog 815 is filled with items that are attractive to members of the public. Each sub-catalog 805, 810 and 815 inherits the rules of base catalog 800 however each sub-catalog also has new rules added to it. Sub-catalog 815, for example, has rules added to it that excludes items that would not be applicable to the general public, such as a mixture of business related hardware and software packages for example.

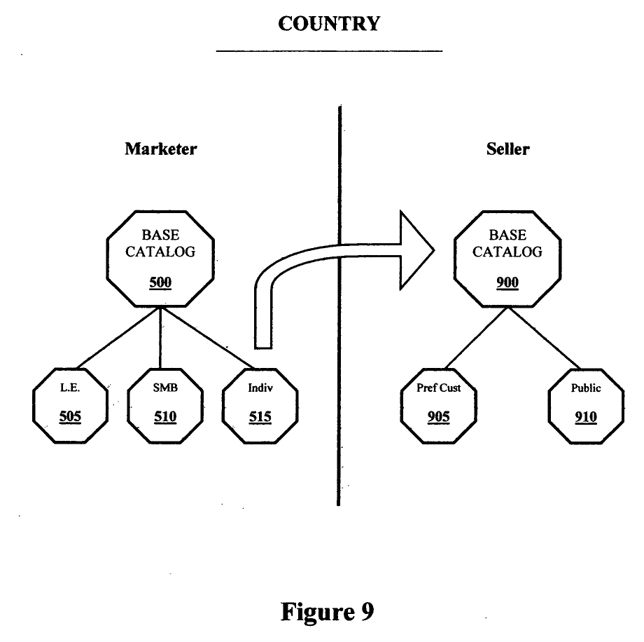

FIG. 9 illustrates an example of one of the marketer's segmented catalogs, catalog 515 in this example, being used as the parent catalog for a seller's base catalog 900. Segmented catalog 515 was previously filled by the marketer with items that he believed would be attractive to individual customers. During negotiations with the seller, the marketer decided that his segmented catalog 515 would be the best catalog to authorize the seller to sell from. Thus catalog 515 is used as the parent catalog for the seller's country specific base catalog 900. As such, the rules that are applicable to catalog 515 are inherited by catalog 900. When the seller accesses his catalog 900, the inherited rules along with any explicit rules that were added by the seller are applied to the items (data) in effect for the seller's location and the catalog 900 is created. In FIG. 9, the seller subsequently segments his base catalog 900 into targeted catalogs 905 and 910, which target the seller's preferred customers and the public, respectively.

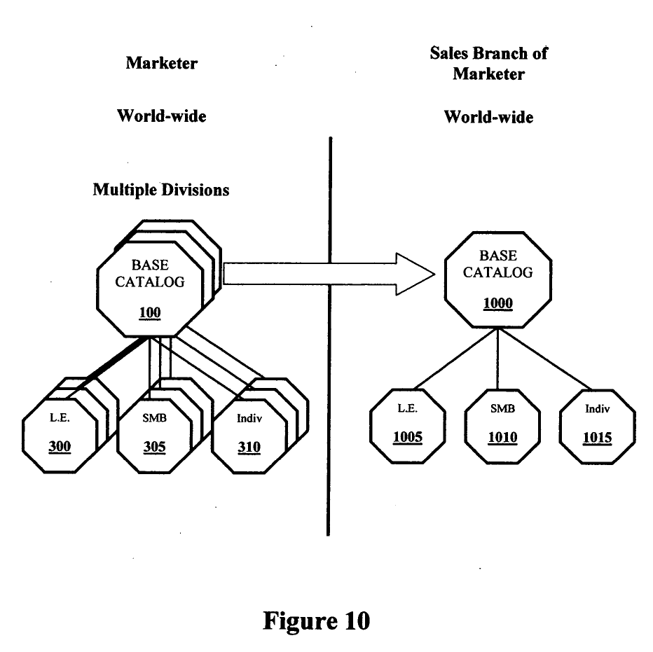

FIG. 10 illustrates an example of catalog inheritance across participant types in the present system. In this example, three base catalogs from three divisions of the marketer are inherited by the sales branch of the marketer and consolidated in base catalog 1000. It may seem that this example is merely an internal transfer, and it could occur that way however, in the preferred embodiment the sales branch and the three divisions are remotely located. Further, the present system may be used with multiple participants each running different software, which is discussed below in conjunction with the customer capabilities tree. Returning to FIG. 10, world wide base catalog 100 is one of the catalogs inherited by world wide base catalog 1000 of the sales branch. Immediately after inheritance, the sales branch is able to create segmented catalogs 1005, 1010 and 1015 each catalog being tailored for a specific audience. In the example of FIG. 10, the sales branch has created sub-catalogs specifically for large enterprises (LE), small and medium businesses (SMB) and individuals (Indv). These sub-catalogs 1005, 1010 and 1015 are each non-exclusive catalogs, meaning that it is possible for two or more of the segmented catalogs to contain the same item. Of course, each of the catalogs could also contain different pricing rules relating to the same item such that the same item could be listed in the different catalogs at different prices.

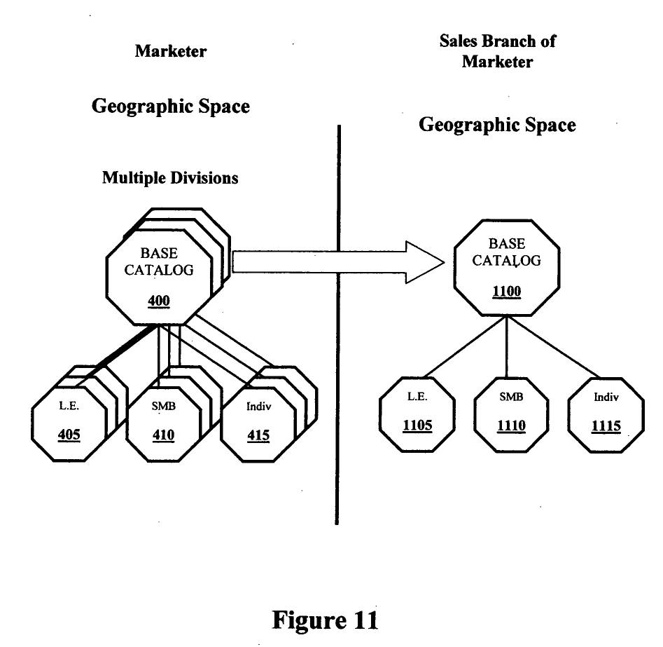

In FIG. 11, a similar inheritance as in FIG. 10 takes place however, in this example the catalogs being inherited are limited in application to a specific geographic space, such as a group of countries, an individual country or an area defined by a participant. Again, three base catalogs from three divisions of a marketer are inherited by the sales branch of the marketer. In the preferred embodiment the sales branch and the three divisions are remotely located. Geographic specific base catalog 400 is one of the catalogs inherited by geographic specific base catalog 1100 of the sales branch. Immediately after the inheritance, relationships are defined and the sales branch is able to create segmented catalogs 1105, 1110 and 1115 with each catalog being targeted toward a specific audience. In the example of FIG. 11, the sales branch has created sub-catalogs specifically for large entities, small and medium businesses and individuals. Again, the sub-catalogs 1105, 1110 and 1115 are each non-exclusive however, this is not to say that the three catalogs couldn't end up with items that no other catalog includes, however this is not likely to happen.

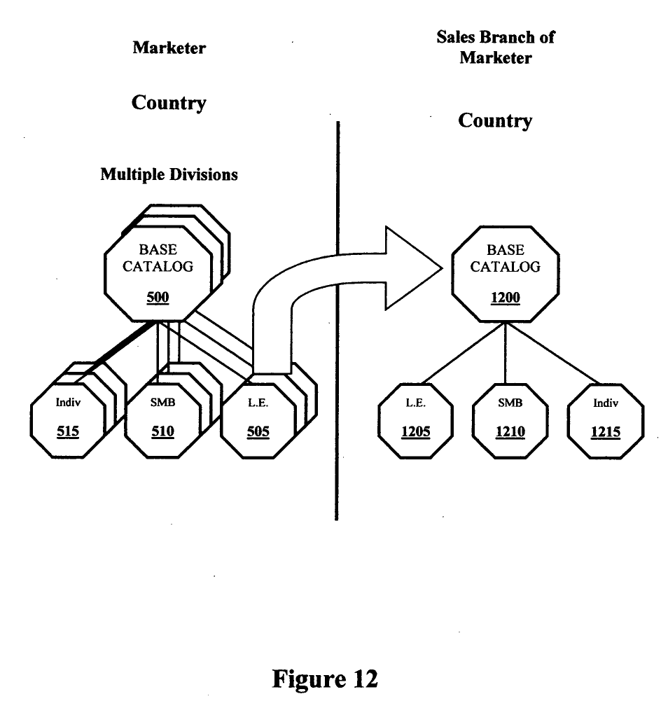

FIG. 12 illustrates the inheritance of three segmented catalogs 505 by base catalog 1200, the sales branch's country specific base catalog. In this example, the segmented catalogs 505 each target large enterprises. Immediately after inheritance, base catalog 1200 is able to create segmented catalog 1205, which targets large enterprises in that specific country. Such organization allows for the immediate creation of many large enterprise catalogs for multiple sellers within the specified country. This process is of course able to be repeated in multiple countries as well. The number of catalogs that can be immediately created for use within a country are only limited by the number of authorized sellers within the country. The same is true for the small and medium business and individual catalogs, 510 and 515.

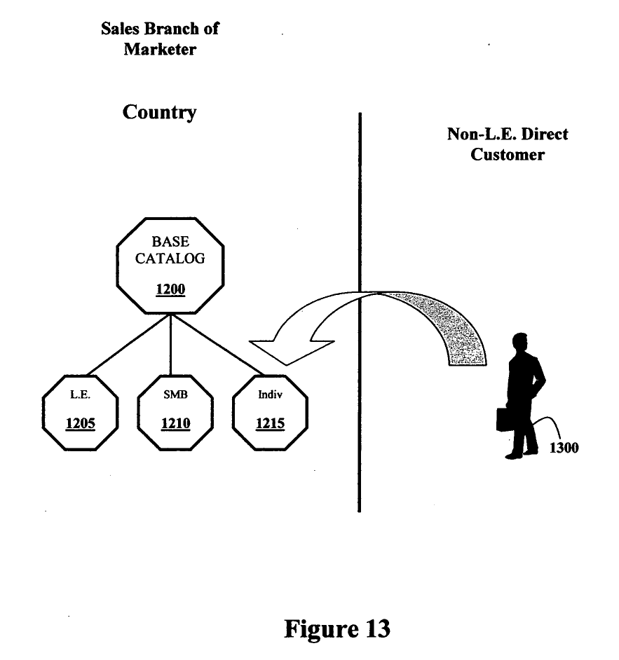

FIG. 13 illustrates the proverbial “rubber hitting the road”, wherein the catalog for individuals 1215 within a specific country has been created through a series of inheritances and made available to the targeted audience, individuals 1300. Segmented catalog 1205 is similarly made available to large enterprise customers within the country. Segmented catalog 1210 is likewise made available to small businesses within the country. With core data at its center, the present system instigates a value chain store concept that can liberate a business from having to negotiating with customers at every turn. Instead, rules are established that govern which products are offered to which segments, in which customer catalogs, and at what prices, per contractual terms and conditions, then the data is allowed to flow uninhibited. When customers log on to one of the present websites or talk to a telephone sales representative (Telesales rep), real-time data is available to them so they can immediately make purchases without someone at the marketer's corporation holding up the sale.

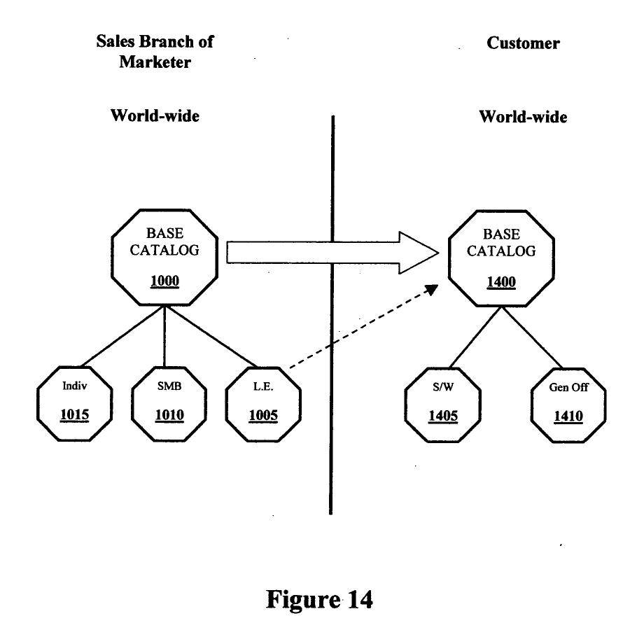

FIG. 14 illustrates another example of inheritance across participant types, specifically the inheritance of the sales branch's world wide base catalog 1000 by a world wide customer's base catalog 1400. Referring back to FIG. 10, the sales branch's base catalog 1000 inherited the majority of its rules, or filters, from base catalogs of multiple divisions of the marketer. Now, in FIG. 14, the former “child” catalog 1000 acts as the “parent” catalog 1000; child catalog being defined as the catalog receiving rules (filters) in the present inheritance system, and parent catalog being defined as the catalog from which rules (filters) are received. After the world wide customer in FIG. 14 inherits its rules, administrators at that level can further tailor the catalog 1400 by adding explicit rules to catalog 1400. Segmented catalogs 1405 and 1410 can then be created by adding rules which exclude unwanted items, for each segmented catalog, and then applying the rules to the items in effect at that location. In an exemplary embodiment, the viewable catalog for base catalog 1400 includes the viewable catalogs of the segmented catalogs 1405 and 1410. The viewable catalogs for 1405 and 1410 are presented as tabs across the top of the screen for viewable base catalog 1400. In an alternative embodiment, the customer's base catalog 1400 is able to inherit its rules from LE catalog 1005.

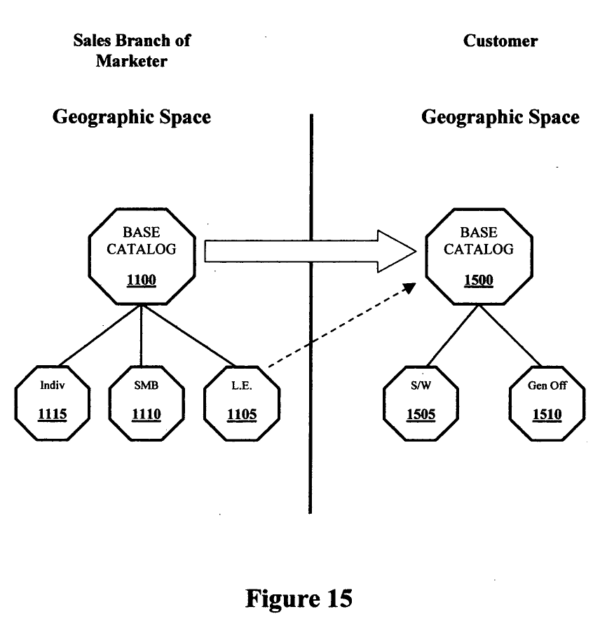

FIG. 15 illustrates the sales branch's geographic space (GEO) base catalog 1100 being inherited by a customer's GEO specific base catalog 1500. Referring back to FIG. 11, the sales base catalog 1100 inherited the majority of its rules, or filters, from base catalogs of multiple divisions of the marketer. In FIG. 14, again a former “child” catalog 1100 now acts as the “parent” catalog 1100. After the geographic space specific customer in FIG. 15 inherits his catalog 1500, administrators at that level can further tailor the catalog 1500 by adding explicit rules. Segmented catalog 1505, which targets audiences that are interested in software, can then be created by adding rules that exclude non-software related items to the rules that are inherited from base catalog 1500. Segmented catalog 1510 is created in a similar fashion however the rules that are added to the inherited rules would exclude non-general office items. The rules associated with each segmented catalog 1505 and 1510 are each applied to the same set of items, in turn, to create the segmented catalogs. Again, the viewable catalog for base catalog 1500 can include the viewable catalogs of the segmented catalogs 1505 and 1510. The viewable catalogs for 1505 and 1510 can be presented as tabs across the top of a screen of viewable base catalog 1400. In an alternative embodiment, the customer's base catalog 1500 inherits its rules from LE catalog 1105.

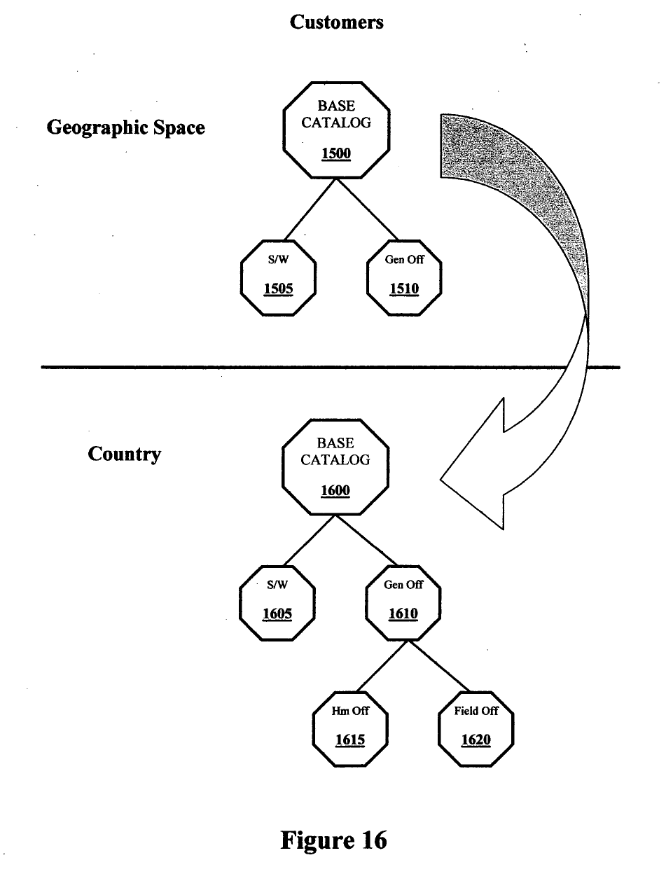

FIG. 16 illustrates the creation and subsequent segmenting of a customer's country specific base catalog 1600. It is worth mentioning again that “customer” as used herein includes retailers, wholesalers, marketers, developers, manufacturers, distributors and individuals. Explicit rules can be added to base catalog 1600 by administrators at that level to further tailor the catalog. After base catalog 1600 is created, administrators at that level can segment the base catalog into catalogs that target specific audiences within the specified country. In FIG. 16, two segmented catalogs 1605 and 1610 have been created. Catalog 1605 includes software (S/W) products that will be of interest to anyone looking to make more efficient use of their computers. Catalog 1610 includes general office (Gen Off) supply products and is intended to target all businesses. Catalog 1610 is then segmented into even more specific catalogs 1615 and 1620. Home office (Hm Off) catalog 1615 is designed to include those products in catalog 1610 that are applicable to a home office. Field office (Field Off) catalog 1620 is designed so that it includes those products from catalog 1610 that are applicable to field offices. It is worth noting that general office catalog 1610 can also be created through direct inheritance of the rules from general office catalog 1510. General office catalog 1610 may also then be further segmented into home office catalog 1615 and field office catalog 1620.

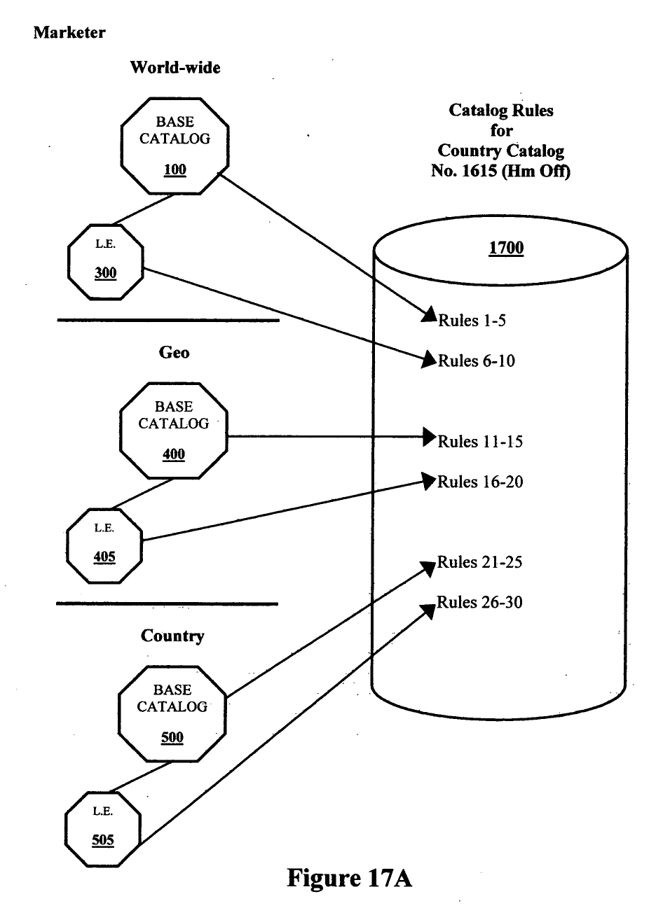

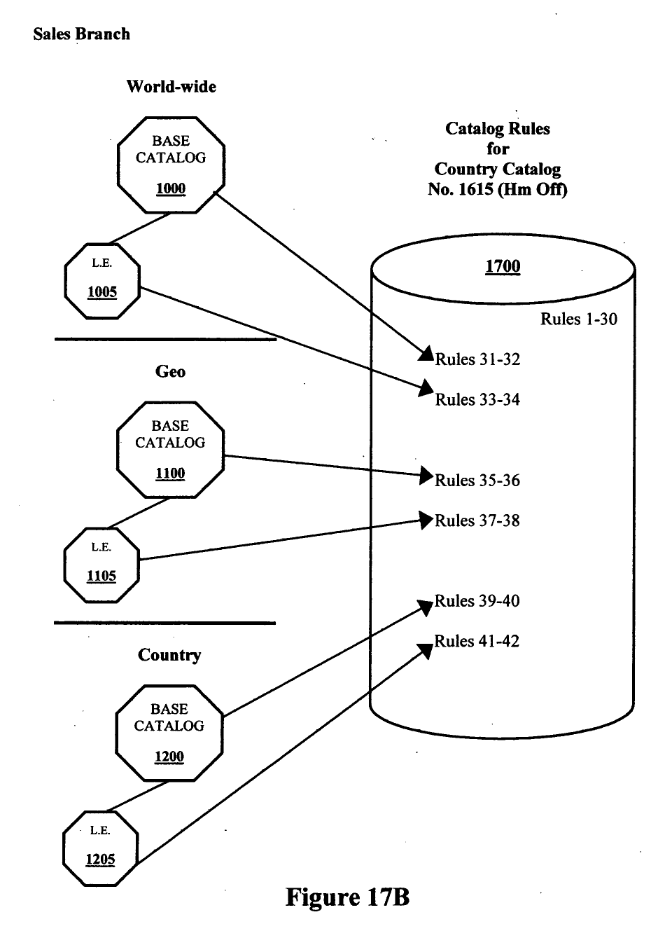

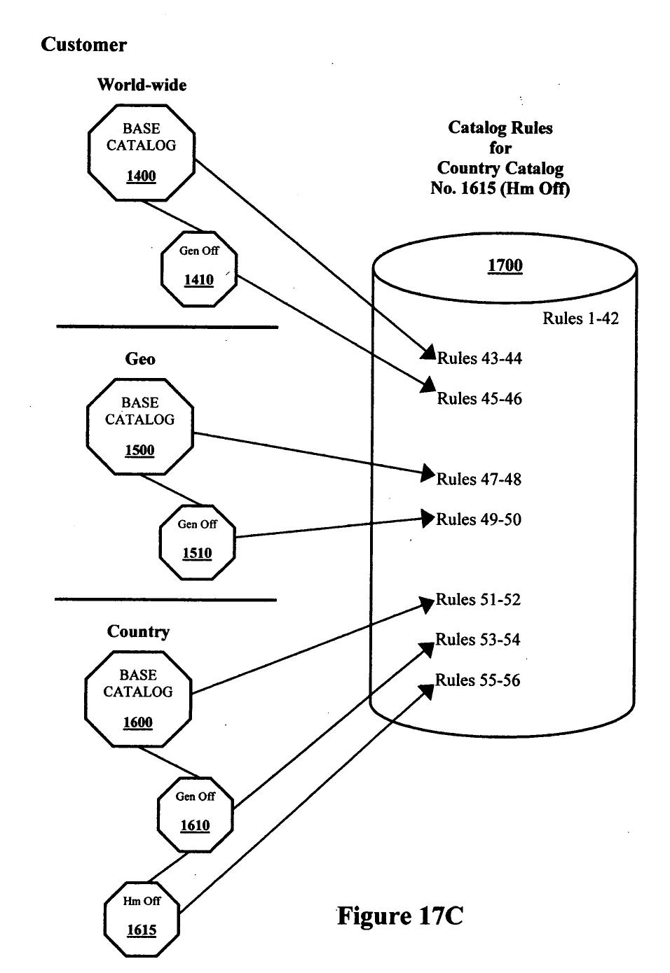

FIG. 17A illustrates the first steps in creating the country specific home office catalog 1615, shown in FIG. 16. Database 1700 is used to consolidate all of the rules from all of the ancestor catalogs of home office catalog 1615, starting with the highest or most distant ancestor. It should be noted that the rules can be stored in any memory or storage device and the use of a database is not a requirement. The highest level in this case is the marketer's world wide base catalog 100. The rules from base catalog 100, rules 1-5 in this example are stored in database 1700. Next, the rules from each of the remaining marketer's catalogs, from which home office catalog 1615 inherited rules, are added to database 1700, in order of seniority. Thus, the rules from all applicable world wide catalogs are added to database 1700 before any rules from more narrowly defined catalogs. In this example, large enterprise catalog 300 is the only other applicable world wide catalog. After all world wide rules have been stored, rules from the next lower level are added to the database 1700 in order of seniority. Thus the rules from the catalogs for the geographically defined space, base catalog 400 and large enterprise catalog 405, are stored in database 1700. Rules 11-15 and 16-20 are added from catalogs 400 and 405 respectively. Next the marketer's catalogs for the specific country are added in order of seniority. Rules 21-25 are added from base catalog 500 and rules 26-30 are added from large enterprise catalog 505.

FIG. 17B continues the creation of country specific home office catalog 1615. At this stage, all of the rules from the marketer's sales branch are stored in database 1700 in order of seniority. The sales branch's world wide catalogs, 1000 and 1005, contribute rules 31-32 and 33-34, respectively. Next the rules from the sales branch's geographic space catalogs, 1100 and 1105, are added to database 1700. Then the rules, 39-40 and 41-42, from the sales branch's country specific catalogs, 1200 and 1205 respectively, are added to the database 1700.

FIG. 17C illustrates the last stage of rule consolidation. At this stage, rules from all of the customer's catalogs, from which home office catalog 1615 is a descendant, are added to database 1700 in order of seniority. Rules 43-44 and 45-46 are contributed by the customer's world wide base catalog 1400 and general office catalog 1410, respectively. Rules 47-48 and 49-50 are received from the customer's base catalog 1500 and general office catalog 1510, respectively, for the geographically defined space. Finally, the rules for the customer's catalogs for the specified country are added to database 1700 in order of seniority. Country specific base catalog 1600 contributes rules 51-52. Country specific general office catalog 1610 contributes rules 53-54, and lastly the explicit rules, 55-56, for home office catalog 1615 are added to database 1700.

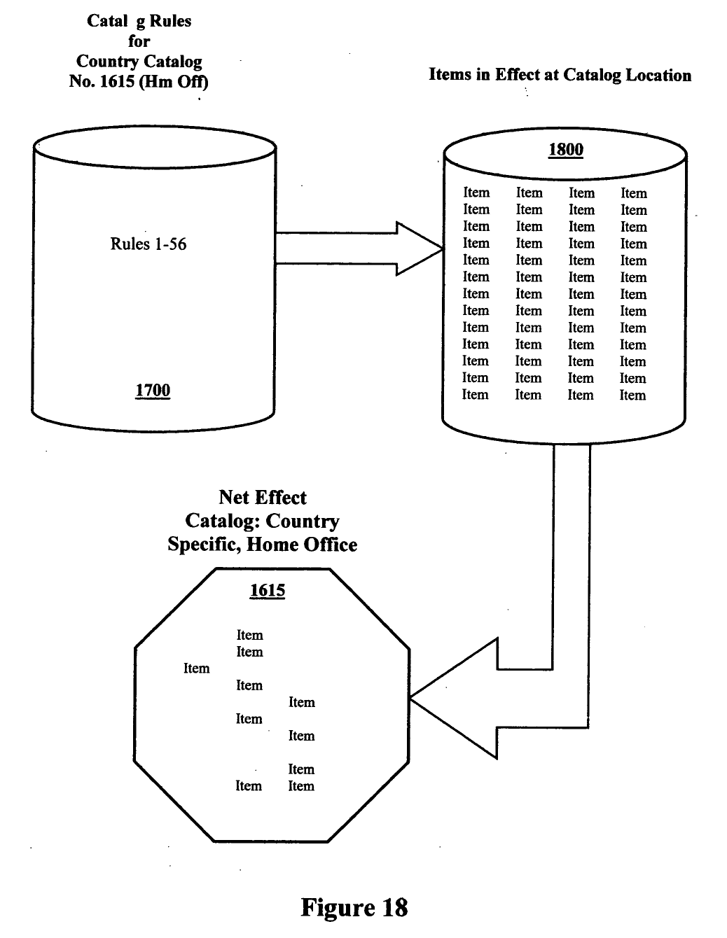

FIG. 18 illustrates the application of the rules, gathered in FIGS. 17A-17C, to the items in effect at the location of home office catalog 1615. The rules in database 1700 are applied to the list of items in database 1800 in ascending order, starting with rule 1. Many of the rules, 1-56, when applied to the items in database 1800, provide instructions as to which items will be included in and excluded from home office catalog 1615. These rules may relate to item categories and producers. Other rules relate to pricing. Catalog 1615 is referred to as a net effect catalog because of the way in which the catalog is produced. Many items will likely be in effect at the target catalogs location. However, not all of the items will be included in the target catalog. Only those items selected by the consolidated rules, and not excluded, will end up in the net effect catalog, home office catalog 1615 in this case.

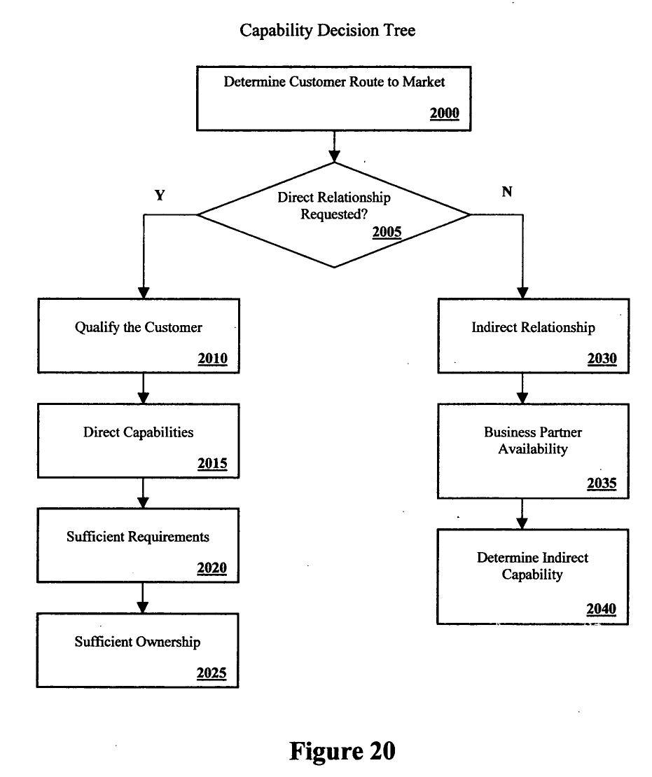

In an alternative embodiment, special rules can be added to the consolidated (net effect) rules based on items requested by the customer. Of course, items requested by the customer during the initial meeting with the customer can be included in the customer's catalog. The initial meeting with a customer is discussed below in conjunction with FIG. 20. However, after the initial meeting and questioning of the customer, the present system allows customer requests for new or different items to be used to change the composition of rules for the customer, and thereby change the customer's catalog. This embodiment implements the paradigm of a customer-personalized catalog that allows efficient, incremental definition and tracking of catalog offerings from proposal time to order execution readiness. This method allows the building of the customer's catalog immediately and incrementally beginning with initial customer contact. Because there is a central source for all offering data there is no lost time in conversion from one enabling business infrastructure to another. From the first meeting with the customer, the configurations are developed and populated in the catalog, proposal and order structures. The states of newly requested items are updated continuously as the items go through the various stages of development within the business. Not only are the items reflected in the catalog but, the catalog can be used as a communication vehicle either internally or externally to selected customer to let all who need know, the status of the item. This method allows the catalog to become a “two way” communication vehicle between the capability requestor and the offering capability provider. The requester can be a customer, a representative of a category of customers, or an internal Brand Marketing organization within the marketer's business. The provider can be any selling organization within or external to the marketer. By turning the catalog into a “two-way” communication vehicle, the marketer is able to capture customer requirements directly into the catalog. Administrators for the marketer are able to select “capabilities” from a central catalog of all of offerings (hardware, software, services and capabilities), scan for similar capabilities based on attributes of a customer requirement and add newly requested capabilities into the catalog at requirements gathering time. The provider only needs to decide whether they are going to offer the capability as service for sale to the customer or as part of an overall offering to the customer. A capability is defined in the present method as a service that must be in place to satisfy a customer's requirement for an offering (it may be itself an offering) or that must be enabled for a customer to do business with the provider. This is not the traditional definition of a capability and has not traditionally been part of a catalog's content. An example of a capability is a special type of communication link between the marketer and a customer. Using the present catalog structure allows the requester to build the capability description in a manner that fits his exact requirements. This allows the provider to respond to this request with precision and speed. Precision is achieved because the requestor must conform to the constructs of the catalog structure. Thus the capability is captured and presented in a form that is ready to process by the provider. Speed is achieved because previously ambiguous textual descriptions of a capability that cause constant dialog between the requestor and the marketer are minimized. Speed is also achieved by eliminating the need to transcribe the capability requirement from a textual description into a “Catalog Offering” in a catalog that can be offered to customers. This also avoids a second opportunity for misinterpretation and introduction of errors. Because of the rigor in which the requirements are defined, a near real-time search can be done to recognize capabilities that are near equivalents. If they satisfy the customer's requirements, enormous costly duplication is avoided.

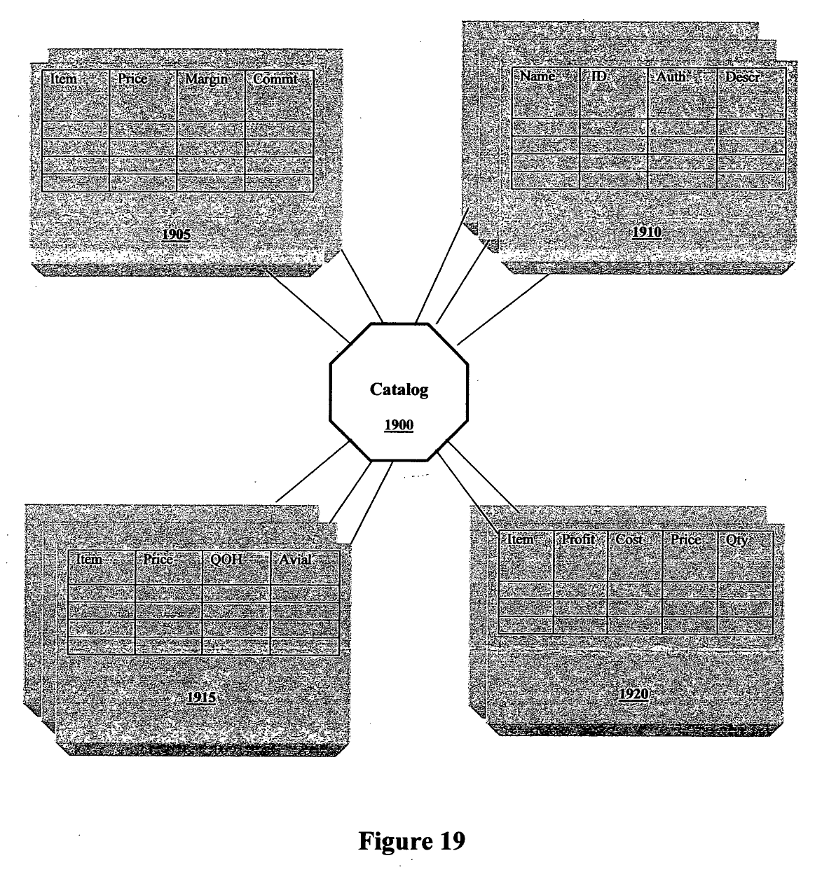

FIG. 19 illustrates some of the different views, or screens, that are available within an exemplary viewable catalog 1900 of the present system. The viewable screens of the present system are examples of capabilities that are inherited from higher level catalogs. Screen capabilities are selected, by rules, depending on the type of catalog and type of participant, among other criteria. Exemplary screens 1905 are tailored for a seller and provide the seller with information regarding the items available for sale within and items that have been ordered from catalog 1900. The first screen for the seller allows the seller to view the price and profit margin for each item. The first screen also allows the seller to make comments regarding any of the items. Another screen available to the seller allows the seller to view the status of items ordered by customers. Exemplary screens 1910 are tailored for administrators of the catalog 1900. Screens 1910 allow for a consolidated view of all persons authorized to access catalog 1900 and to what extent they are granted access. Other views within screens 1910 allow the administrator to segment the catalog into one or more catalogs that target specific audiences, to add explicit rules to catalog 1900, to delete optional rules applied to the catalog, and to request a change to mandatory rules applicable to catalog 1900. Exemplary screens 1915 are tailored for purchasers. Screens 1915 allow purchasers to browse and search for items, order items, and get status on ordered items. Screens 1920 are tailored for price setters, or pricers. Screens 1920 show the pricers current profit margins and pricing rules. Screens 1920 also allow the pricers to change prices and request changes to pricing rules. FIG. 19 illustrates that multiple views of the same catalog are available to different persons, depending on their relation to the catalog 1900. Not all viewable catalogs will have all of the screens shown in FIG. 19. Of course, other catalogs may have other views not shown in FIG. 19, which include pictures and videos for example.

Managing Catalogs.

When customers log on to one of the present websites or talk to a Telesales rep, real-time data is available to them so they can immediately make purchases. To make this happen, a layer of intelligence on top of the core data is needed that directs the data down the appropriate paths. This can be done in an events driven object oriented programming environment using a relational database and well-defined data model. Events are major occurrences that initiate or reflect completion of processes that a business needs to do to execute work. An example of an event in the PCD (personal computer division) is when a customer is checking out purchased items and a “ship date” is committed to. Committing a ship date is an event that will be populated in an Events Table. An exemplary Events Table contains the following information: a unique computer generated event ID; the type of event “commit ship date” in this case; the date stamp when the event occurred or will occur; and whether or not this is a historical event or scheduled event. This Events Table is related in a relational database to many other tables, such as an Event-Participant Table (who executed the event), and an Event/item Reference Table, which points to the item for which the event was executed. The “commit ship date” schedules other events and populates the Events Table with a “release product”, “pull inventory”, “build”, “ship”, and “invoice” scheduled events. These events will all be assigned a future date indicating when they should be completed. Management can run reports to compare actual vs. scheduled events and predict if the business is at risk of missing future dates. Over time, analysis of the historical data will point to weaknesses in the processes that can be corrected, and also gives management a better view of how the business is doing at any given point in time.

In traditional programming environments, status codes are used to identify what stage a data element is in. When a data element receives a new status, its status code is overwritten. To track historical data in this traditional environment requires separate status tables be set up for each item. This involves significant programming and takes up more database space than the present events-driven method. Events are very effective for managing routine business tasks such as product life cycle. When the product is released, the system writes the date of the event in the Events Table and schedules an End of Life (EOL) cycle event. When this EOL date is reached, the system triggers another event to remove the product from the customer catalog and prevent customers from ordering it. This level of accuracy not only improves customer satisfaction but also reduces the need for large staffs of customer service personnel to research problems. The present method uses data rules in real-time to determine what is included or excluded in a customer catalog. When a component reached its EOL, any catalog or order is immediately aware of the change because every time the catalog or order is accessed the rules are used to inquire against the item to determine its status. The event representing the change of state for the item is maintained independent of the item itself, and is understood at the geographic location in which the item is fulfilled. Therefore, an item may be EOL in one catalog and still orderable in another in another geographic area. Within a given area all catalogs instantaneously have the same EOL understanding. When managing transitions in a customer catalog, since items are included via the application of data inclusion/exclusion rules, as one item goes obsolete and a new one becomes effective and automatically replaces the obsolete item in the catalog. This is because the rules make the determination. No one has to update each individual catalog for these changes. This provides greater management control when switching manufacturers, because an item reaches its EOL, for example. When this happens the new manufacturer can provide the item (if the filters allow this) and the customer never perceives an affect on their catalog. However, the rules in the form of data constructs and processes that use these constructs support real-time recognition of these situations so that the customers can be immediately apprised of the situation. If an item has a “replacement via substitution” relationship established with the replacement items, then the affected customers can be notified of the replacements in advance. This has a positive effect on customer satisfaction and increases revenue. For example an existing 6-GB disk drive may be going end-of-life but is being replaced by a 10 GB drive at a small increase in price, potentially providing higher value to the customer.

Another benefit of an events-driven environment is the flexibility to adapt to change. If the business requires a change in process, instead of writing code to implement the change, new events and rules can be defined to implement the new process. Each item is “effective dated” meaning it is assigned a begin date and an end date, which define when the item is in effect. The begin date may relate to the date a participant plans to release an item in specified geographies. The effectivity date is tracked as a business event. If the release date arrives and a participant is not ready to release the item, he merely changes the effectivity date, which is stored with the data. Ideally, real-time events work in conjunction with the core data in a centrally managed control tower to provide the business with a real-time business management system. At the core of the control tower is a common repository that serves as a world wide data collection, activity monitoring, and operational reporting database. Personnel such as Telesales reps, developers, and all levels of management will have a synchronized set of common data and metrics. Telesales will have a better view of the supply chain as well as product promotions that may impact what products and prices they offer to customers. Executives will have access to pre-tax income, cost information and customer buying trends on a daily basis rather than having to wait days, weeks, or months for staff to collect and interpret the data. Management can react quickly to changing market conditions and if required, developers can implement strategic changes quickly, without lengthy IT development cycles. In this way, the cost of the executive management system can be reduced, be more responsive to customers and shareholders, and implement strategic changes more rapidly than is possible today.

Sales Advice.

FIG. 20 is a flow chart showing the basic steps involved in determining the capabilities of a potential customer of the present system. A capability decision tree, such as the one illustrated in FIG. 20, is employed during the initial meeting with the potential customer. Actual decision trees are customized to the type of catalog and customer. Thus a LE decision tree is different than an individual's decision tree. The capability rules that build the decision trees are part of the present inheritance system. The decision trees allow the sales person to interactively evaluate a customer's historical customer profile and preferences along with their immediate answers to questions. This evaluation uses data driven rule constructs acting on this data to navigate the customer to a catalog of offerings and capabilities. The rule constructs and the type of target data for the rule can be changed in near real-time to support a rapidly changing business climate. The implementation is complex but it results in a simplistic view of the marketer's offerings capabilities from an end-user's entitlement perspective. The first step 2000 is to determine the customer's route to market. How is the customer going to present his products to his audience? Does the customer want to take advantage of the electronic age and let computers help him operate more efficiently? If so, then we move on to step 2005, where it is decided whether the customer will have a direct or indirect relationship with the marketer. In a direct relationship, the marketer deals directly with the end user customer. In an indirect relationship, there is some participant (a sales organization) between the marketer and the end user. If a direct relationship is requested, then we move to step 2010 to determine if the customer qualifies for a direct relationship. In step 2015, the capabilities of the customer, such as the type and amount of computer hardware and software the customer owns, is determined. The present system includes a configurator that allows compatibility with multiple different computer systems. Commercially available configurator applications include SAP, Siebel, and Selectica, with Selectica being the preferred configurator. In step 2020, the requirements of the customer are determined. If the customer has sufficient requirements then we proceed to the next step. In step 2025, it is determined if the customer has a sufficient amount of ownership of the entity that he represents. If the customer fails any of the requirements for a direct relationship with the marketer, then an indirect relationship will be suggested to the customer. Customers that request an indirect relationship and customers that fail to qualify for the direct relationship are taken to step 2030 where an indirect relationship with the marketer is discussed. In step 2035, it is determined whether or not a business partnership is available to customer. A business partnership is usually looked for within specific countries of interest to the customer. The partnership can be between the customer and any other participant in the present system. In step 2040, the indirect capabilities of the customer are determined so that compatibility between all parties can be set up.

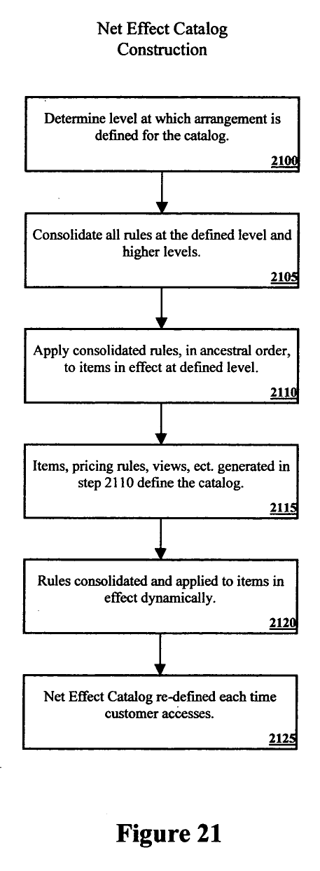

FIG. 21 is a flow chart that lists the major steps for creating a net effect catalog in accordance with the present system. These steps have previously been shown graphically in FIGS. 17A-17C, and 18. In step 2100, the level at which the new catalog is to be created is determined. Possible levels include world wide, geographic space, and country specific. Of course other levels may also be defined, for segmented catalogs as an example. In step 2105, the rules to be associated with the new catalog are consolidated, starting with the highest level (ancestor) from which the new catalog is derived and continuing through each descendant catalog until the level determined in step 2100 is reached. These rules are stored in ancestral order in a database, wherein the rules associated with the highest level catalog are listed first. Each level in the present system has an associated list of items that are in effect for that level. For example, documents in the Japanese language would be effective at levels where the Japanese language is used, and would not be in effect where the Japanese language is not used. In step 2110, the rules consolidated in step 2105 are applied to the items in effect at the level determined in step 2100. The rules that relate to inclusion and exclusion of items dictate which items will be included in the new, net effect, catalog. In step 2115, the items that are selected and not excluded are consolidated and those items, actually the item ID's, define the net effect catalog. The new net effect catalog is immediately available for access by a customer. Step 2120 highlights the dynamic aspect of the present system, wherein the net effect catalog created in step 2115 can be changed by changing any of the rules that were consolidated in step 2105. Step 2125 indicates how the dynamic changes to the new catalog take place. The items in effect at the defined level and the rules associated with the net effect catalog are stored separately. The net effects catalog is not created until a customer accesses the catalog. Upon access, the rules in effect at that time are applied to the items in effect at that level, and the customer's viewable catalog is created. Thus, if one or more rules are changed after a customer's first session with the catalog, the catalog will be changed in accordance with the changed rules, and the changes will appear in the customer's viewable catalog the next time the customer accesses the catalog. In other words, any newly released (effective) items in the customer's geo that fit the existing rule inclusion criteria will also be included in the catalog the next time the catalog is accessed. From this example it should be clear that a viewable catalog is not stored as a complete catalog when it is not being accessed by a customer. Rather, a dynamic set of rules and items remain associated with the customer, and the viewable catalog itself is created dynamically each time the catalog is accessed.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

1. A computer generated machine-readable program that allows an organization to manage and view all arrangements that are in effect between the organization and one or more participants with which the organization conducts business, wherein the arrangements are any business relationship, and further wherein one or more presentations can be created based on a type of arrangement to be viewed, the method comprising the steps of:
storing all of the organization's arrangement items, wherein arrangement items include any construct that is used to build a business relationship;
creating rules that select specific arrangement items for inclusion in a presentation;
selecting the type of arrangement presentation to be created, wherein at least one participant is also selected;
consolidating a set of rules based on the type of arrangement to be created and the at least one selected participant; and,
applying the set of rules to the organization's arrangement items, wherein the set of rules selects specified arrangement items and the selected arrangement items are presented as a viewable presentation that shows the selected type of arrangement between the organization and the at least one selected participants.

2. The program of claim 1, wherein the organization's arrangement items include contract terms and conditions, business relationships including marketing and distributor relationships, customer orders and requests, accounting plans, industry standards, certification requirements, letters of agreement, government regulations, and powers of attorney.

3. The program of claim 1, wherein the at least one selected participant is a supplier, marketer, distributor, wholesaler, retailer, developer, manufacturer, or end user customer.

4. The program of claim 1, further comprising the step of:
inheriting the consolidated set of rules by a lower level entity associated with the organization, thereby allowing the lower level entity to create the viewable presentation that shows the selected type of arrangement.

5. The program of claim 1, wherein defined events are tracked and used to trigger management actions for the viewable presentation.

6. In a rules based computer program having machine readable code that allows a first participant in the system to inherit rules from a marketer wherein, the rules are used to create a catalog for the first participant each time the participant logs on to the system, the method comprising the steps of:
listing all items that are available world wide from the marketer in a marketer's base catalog wherein, the items include products, services and capabilities offered by the marketer and each item is assigned an effectivity period, during which a specified item is considered to be in effect, and an effectivity location, wherein the effectivity location defines an area that the specified item is considered to be in effect;
associating a base set of rules with the marketer's base catalog wherein, the base set of rules relate to item inclusion or exclusion, pricing, or presentation layout, and each rule is capable of being inherited by the first participant and by other participants, and further wherein each rule is assigned an effectivity period, during which a specified rule is considered to be in effect, and an effectivity location, wherein the effectivity location defines an area that the specified rule is considered to be in effect;
authorizing the first participant to sell items that are listed in the marketer's base catalog wherein, the first participant is provided with identification information that the participant uses to log on to the system;
assigning a subset of rules to the first participant based on the participants situational factors including, location and entitlements wherein, the subset of rules are a subset of the base set of rules, and the subset of rules determines what items will appear in the first participant's catalog; and,
creating a viewable catalog for the first participant each time the participant logs on to the system by applying the subset of rules to the items in effect in the first participant's location;
wherein, changes to the subset of items, because of items that have either come into effect or gone out of effect, and changes to the subset of rules, because of rules that have come into effect or gone out of effect, are automatically represented in the first participant's viewable catalog the next time the first participant accesses his catalog.

7. The program of claim 6, further comprising the step of:
allowing the first participant to add one or more explicit rules to the subset of rules wherein, the first participant is able to tailor his catalog to his needs and needs of his customers through the addition of the one or more explicit rules; and,
adding one or more rules to the subset of rules based on items that have been requested by the first participant, wherein the one or more added rules are used to select the requested items for inclusion in the first participant's catalog.

8. The program of claim 6, wherein the subset of rules assigned to the first participant are either mandatory rules or optional rules wherein, the first participant may unilaterally change or exclude optional rules and the first participant must obtain permission from the marketer before changing or excluding mandatory rules, and further comprising the steps of:
defining the effectivity periods for items and rules with a begin date and an end date; and
defining the effectivity locations for items and rules by a geographic space, wherein the geographic space is one or more postal zones, one or more time zones, one or more political geographies, including countries, or a custom geographic area defined by the marketer.

9. The program of claim 8, wherein the first participant is a business organization and different members of the organization are able to view different portions of the first participant's catalog, and further comprising the steps of:
assigning item identifiers to each item, wherein the item identifier is used to identify what geographic space the item is in effect and can also be used to identify an item as being in effect in more than one geographic space; and
identifying all capabilities that have been selected by the subset of rules for inclusion in the first participant's catalog and initiating steps for installing those capabilities for the first participant, wherein capabilities include warranty level, delivery arrangements, service levels, ordering, invoicing, report creation, shipping label creation, asset management and manufacture integration.

10. The program of claim 6, further comprising the steps of:
authorizing, by the first participant, a second participant to sell items from the first participant's catalog wherein, the subset of rules assigned to the first participant and any explicit rules added by the first participant are automatically inherited by, and assigned to, the second participant;
providing the second participant with identification information that the second participant uses to access a viewable catalog for the second participant; and,
creating the viewable catalog for the second participant each time the second participant accesses his catalog by applying the rules inherited by the second participant to the items in effect in the second participant's location;
wherein, any changes, because of rules or items that have come into effect or gone out of effect automatically appear in the second participant's viewable catalog the next time the second participant accesses his catalog.

11. The program of claim 10, further comprising the step of:
allowing the second participant to add one or more explicit rules to the rules that are inherited by the second participant, wherein the second participant is able to tailor his catalog to his needs and needs of his customers by the addition of the one or more explicit rules, and further wherein the second participant is a second business organization and different members of the second business organization are able to view different portions of the second participant's catalog.

12. The program of claim 6, wherein the step of assigning a subset of rules to the first participant comprises:
assigning the subset of rules to the first participant based at least in part on special requests from the first participant, wherein the resultant catalog for the first participant is populated at least in part with special bid items and called a special bid catalog, and further wherein the all special bid catalogs are tracked by special bid identifiers.

13. The program of claim 10, wherein the rules inherited by the second participant are either mandatory rules or optional rules wherein, the second participant may unilaterally change or exclude optional rules and the second participant must obtain permission from either the marketer or the first participant before changing or excluding mandatory rules.

14. The program of claim 11, wherein the base set of rules, the explicit rules added by the first participant and the explicit rules added by the second participant pertain to inclusion or exclusion of items, pricing of items, or visual presentations.

15. The program of claim 6, wherein the capabilities that are available in the marketer's base catalog include direct and indirect marketing, system administration, ordering, invoicing, reporting, asset management, manufacturer integration, vendor management, warranty, packaging, currency conversion and contract production.

16. The program of claim 6, further comprising the steps of:
notifying the first participant when a requested item is not available and offering a substitute in place of the requested item; and,
allowing for pre-approved substitutes of items and components of items, wherein at least some items are assigned a characteristic and a first value that relates to the characteristic and substitutes for the at least some items have a second value wherein the second value is within a predefined limit of the first value.

17. The program of claim 6, wherein defined events are tracked by the system and the events are used to trigger catalog management actions
